(19) United States
(12) Patent Application Publication
(10) Pub. No.: US 2014/0122270 A1
(43) Pub. Date: May 1, 2014

(54) MANAGING RETURNS USING ELECTRONIC RECEIPTS

(71) Applicants: Stuart Argue, Palo Alto, CA (US); Anthony Emile Marcar, San Francisco, CA (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/665,925

(22) Filed: Oct. 31, 2012

(51) Int. Cl. G06Q 20/20

(52) U.S. Cl. CPC G06Q 20/202
USPC 705/21

(57) ABSTRACT

Systems and methods are disclosed for maintaining an electronic receipt. An electronic receipt is created and stored for a transaction. The electronic receipt is updated for returns and the electronic receipt may be viewable by a user, as a number of versions of the receipt or a markup showing modifications to the transaction. To make a return, a POS may request the some or all of versions of the receipt. An item to be returned for a transaction may be evaluated with respect to the current version of the receipt to determine if the item has been previously returned. An item to be returned may be selected by a user by selecting the item on a graphical representation of the receipt displayed on the user's mobile phone or other computing device.

### BACKGROUND

1. Field of the Invention

This invention relates to systems and methods for managing returns at a point of sale.

2. Background of the Invention

Many stores have generous return policies that allow a customer to return most items for any reason. In many cases a receipt is required if cash is desired. In some instances, where a credit card or some other electronic form of payment is made, returns maybe required to be made to the same account from which payment was made. Where no receipt is present some stores will allow refunds only in the form of in-store credit.

Although this may be essential to customer service and encourage people to purchase with confidence, it leaves a store vulnerable to fraud. It can also be inconvenient for a customer to retain receipts indefinitely in case a return might be needed.

The systems and methods disclosed herein provide novel approaches enable the secure processing of returns without the need for a customer to retain receipts.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a system for processing returns in accordance with an embodiment of the present invention;

FIG. 2 is a block diagram of a computing device suitable for implementing embodiments of the present invention;

FIGS. 3A and 3B are diagrams of interfaces for viewing versions of receipts in accordance with an embodiment of the present invention;

FIG. 4 is a process flow diagram of a method for maintaining electronic receipts in accordance with an embodiment of the present invention;

FIG. 5 is a process flow diagram of a method for initiating a return on a mobile device in accordance with an embodiment of the present invention; and

FIG. 6 is a process flow diagram of a method for processing a return at a point of sale in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

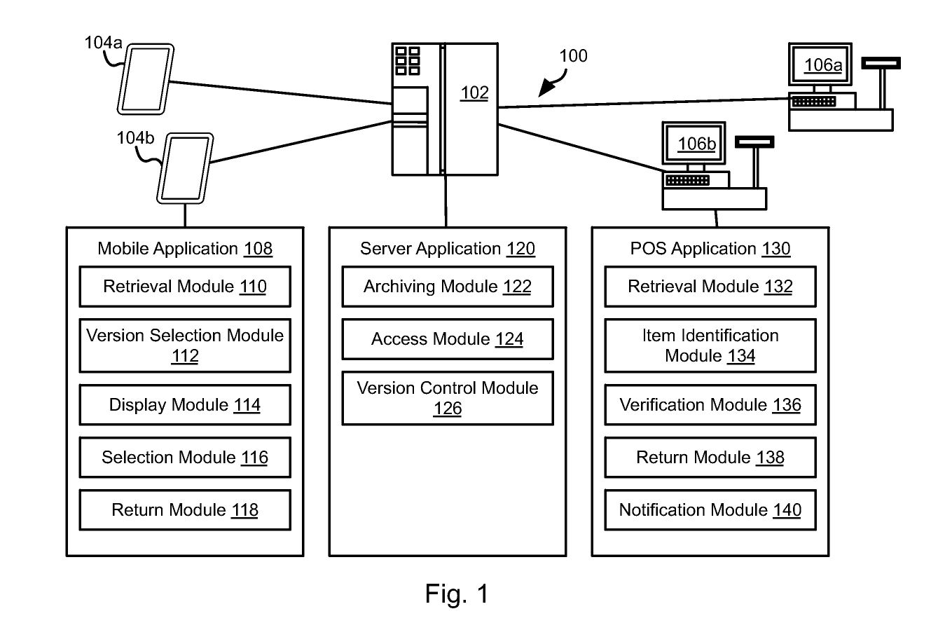

FIG. 1 illustrates a system 100 in which methods described hereinbelow may be implemented. The system 100 may include a server system 102 that may be embodied as one or more server systems each including one or more processors that are in data communication with one another. The server system 102 may be in data communication with one or more user computers 104a, 104b and one or more point of sale (POS) locations 106a, 106b. For purpose of this disclosure a POS location 106a, 106b may include one or more POS devices that are operating within a POS location 106a, 106b. Each POS location 106a, 106b may be part of a POS network that is owned or controlled by a merchant or other entity. In the methods disclosed herein, the user computers 104a, 104b are advantageously mobile devices such as a smart phone or tablet computer. However, some or all of the methods disclosed herein may be performed using a desktop computer or any other computing device as the user computer 104a, 104b. For purposes of this disclosure, discussion of communication with a user or activity by the user may be interpreted as communication with a computer 104a, 104b associated with the user or activity taking place on a computer associated with the user. The POS location 106a, 106b may include any store and may be part of a POS network. In some embodiments, a POS location 106a, 106b may include POS devices operable to process online transactions. In some embodiments, separate computers of the server system 102 may handle communication with the user computers 104a, 104b and POS locations 106a, 106b.

A user computer 104a, 104b may host, execute, or otherwise provide an interface to a mobile application 108. The mobile application 108 may execute some or all of the methods disclosed herein. The mobile application 108 may be hosted locally on the user computer 104a, 104b or some or all of the functionality thereof executed remotely on the server system 102 and an interface provided on the user computer 104a, 104b, such as by means of a web browser or other remote interface.

In some embodiments, the mobile application 108 may include a retrieval module 110, a version selection module 112, a display module 114, a selection module 116, and a return module 118. A retrieval module 110 may retrieve receipt information from the server system 102. The retrieval module 110 may maintain a parallel database of receipt data for the user such that the retrieval module 110 received updated receipt information as it is generated or periodically requests it. The retrieval module 110 may retrieve full receipt information for each transaction or only an identifier, date, or other information sufficient to identify a transaction such that a user may select a receipt and invoke the retrieval module 110 to retrieve the receipt as needed.

The version selection module 112 may enable a user to request and/or invoke display by the user computer 104a, 104b of a version of a receipt. After each return is made of one or more items purchased in a transaction, a new version of the receipt may be generated or the change to the transaction otherwise recorded by the server system 102 in association with the transaction. Accordingly, the version selection module 112 may enable a user to navigate among the different versions of the receipt. A display module 114 may use data defining a receipt or version of a receipt to render a graphical representation of a receipt or version of a receipt. The graphical representation of the receipt may resemble or be identical to a printed receipt generated at a POS location.

The selection module 116 may enable a user to select an item listed in a receipt. For example, a displayed receipt or version of a receipt may include interface elements, or data operable as an interface element, to enable a user to select an item on a receipt. The selection may be received to enable the user to select an item for returning for a refund. The return module 118 may enable the user to invoke returning of the item at a POS location. This may include transmitting such information as the item, an identifier of the transaction or receipt in which the item was purchased, an identifier of the most current version of the receipt, or the like.

A server system 102 may host, execute, or interact with a server application 120. The server application 120 may execute some or all of the methods described herein. The server application 120 may include an archiving module 122, access module 124, and a version control module 126.

An archiving module 122 may receive records of transactions from a POS location 106a, 106b. The information may be received in the form of an electronic receipt including some or all of a unique transaction identifier, the items purchased, the prices thereof, any taxes paid, any coupons or discounts applied, and the like. Accordingly, the archiving module 122 may store this information in persistent and accessible format. In some embodiments, only data for recent transactions are kept in a readily accessible format or location.

An access module 124 may receive requests for archived transaction data. The access module 124 may also authenticate those attempting to access data. Where the entity requesting transaction data is a customer, the customer may have an account with associated username and password. Accordingly, the access module 124 may verify the username and password, or some other authentication information such as a public key, provided by the user when attempting to access the transaction data of the customer. Where the entity attempting to access the transaction data is a POS, the POS may likewise provide a user name and password or some other authentication information before being allowed to access transaction data. The access module 124 may receive as part of an access request, a transaction identifier, transaction date, transaction time, customer identifier, and the like. In response to the request, the access module 124 may retrieve the identified transaction data and provide it to the requesting device.

A version control module 126 may maintain an accurate record of modifications to a transaction. This may include recording such information as the date of a return, the item(s) returned, the amount of money refunded, the manner in which the refund was made (credit card, cash, store credit etc.), and the like. Accordingly, the version control module 126 may receive a description of returns or any other activity that may modify a transaction and record a change to the transaction in a database.

A POS location 106a, 106b may host, execute, or otherwise interact with a POS application 130. The POS application 130 may include a retrieval module 132, item identification module 134, verification module 136, return module 138, and notification module 140.

The retrieval module 132 may retrieve a current version, or all versions of a receipt, from the server system 102 for a specific transaction. For example, a transaction identifier may be received at the POS location 106a, 106b and the transaction identifier sent to the server system 102 with a request for some or all of the receipt data for the transaction. The transaction identifier may be input at the POS location 106a, 106b by typing in a transaction identifier by a cashier or customer into a POS device, scanning a barcode or QR (quick response code) encoding the transaction identifier on a mobile phone of a user. Alternatively, the current version or all versions of a transaction may be transmitted to the POS location 106a, 106b without a request for the information from the POS location 106a, 106b. For example, the user may instruct the server system 102 to transmit the transaction identifier to the POS location 106a, 106b. The POS location 106a, 106b to which the transaction information is to be sent may be determined according to proximity of the POS to the user's computer 104a, 104b using GPS data, wireless transmission of a POS identifier to the user's computer 104a, 104b from the POS location 106a, 106b, or input of a POS identifier to the user computer 104a, 104b.

The item identification module 134 may receive an identifier or some other indication of a user's selection of an item to be returned, where the item is listed on an electronic receipt. Various methods may be used to identify an item. The item may be identified by receiving an output of a barcode scanner and locating the item corresponding to the output of the scanner (such as a UPC) in the retrieved electronic receipt. In some embodiments, the identification module 134 may receive an identifier from a user computing device 104a, 104b. For example, a selection received using the selection module 116 may be wirelessly transmitted from the user's mobile device to a colocated POS location 106a, 106b. In some embodiments, a selection from a user on a user computing device 104a, 104b may be transmitted to a POS location 106a, 106b by way of the server system 102.

The verification module 136 may evaluate whether the item identifier received corresponds to an item of a transaction that has already been returned. If so, then the return may be declined. Otherwise, the return may be authorized to proceed.

Once an electronic receipt and item identifier have been received, a return module 138 may process the return as known in the art. This may include authorizing a refund to a credit card, authorizing a cash refund, authorizing store credit, or the like. A notification module 140 may notify the server system 102 once a return has been completed and the server may update an electronic receipt accordingly. For example, the notification module 140 may return a transaction identifier and one or more identifiers for items returned to the server system 102.

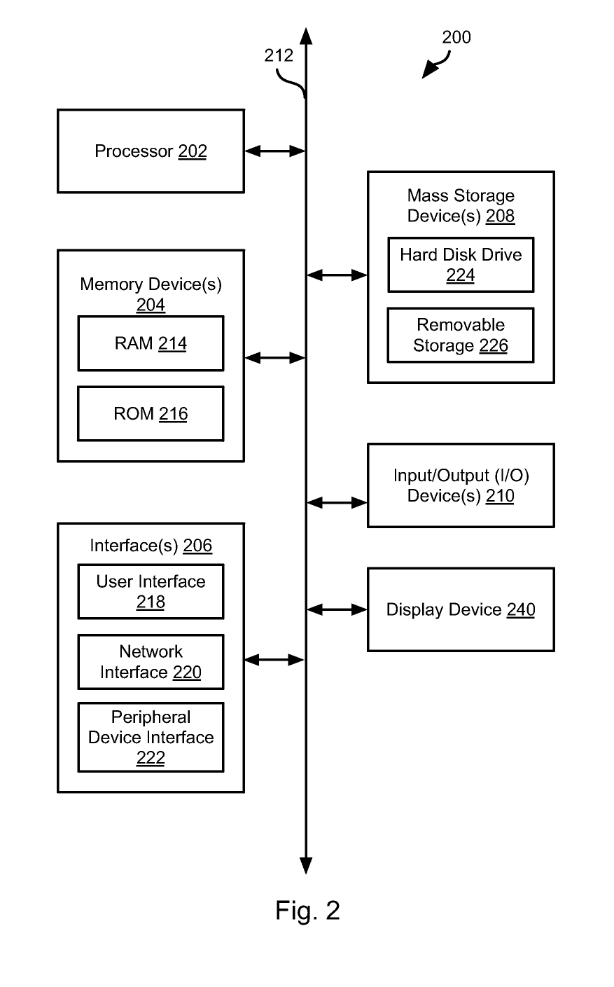

FIG. 2 is a block diagram illustrating an example computing device 200. Computing device 200 may be used to perform various procedures, such as those discussed herein. A server system 102, user computer 104a, 104b, and POS devices of a POS location 106a, 106b may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

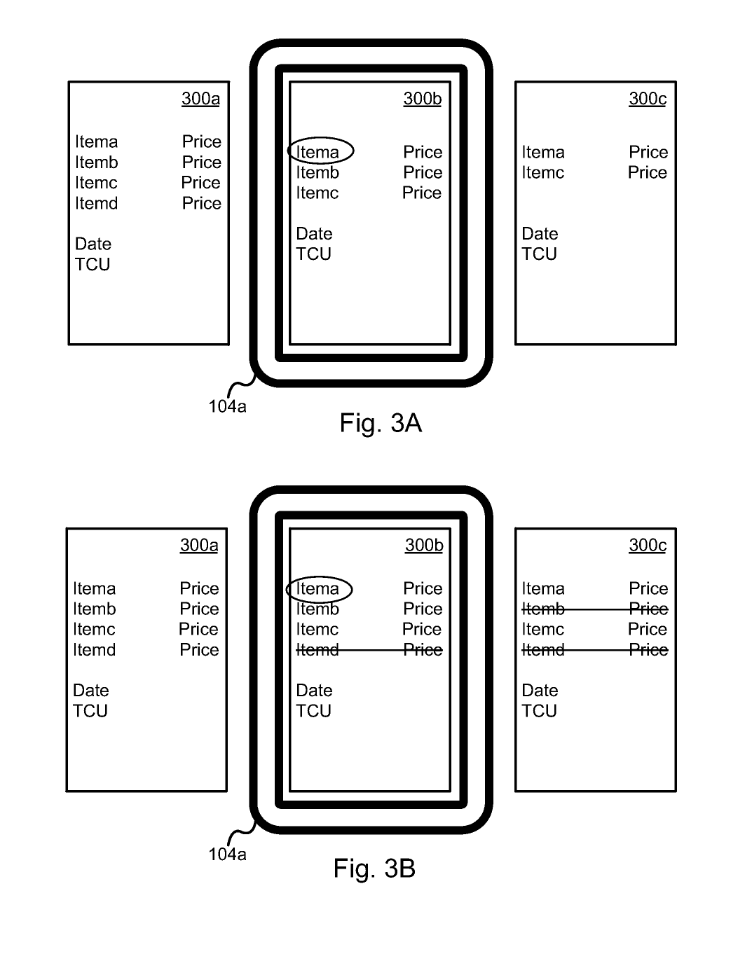

FIGS. 3A and 3B illustrates examples of a user interface that may be used by a user to view different versions of a receipt and to select specific items to return. In some embodiments, the different versions 300a-300c of the receipts may be available for a user to scroll through as known in the art of many touch screen devices. Different versions may also be selected for display from a list. As shown in FIG. 3A, in some embodiments, different versions 300a-300c may each reflect only the current state of the transaction corresponding to the receipt after a return. Alternatively, as shown in FIG. 3B, the different versions of a receipt may include markings to show how the receipt was modified as a result of each modification (e.g. return of an item). In practice, as shown by the circled text, a user may select an item on a version of the receipt to indicate intent to return the item. The item may be graphically highlighted, such as by circling, underlining, changing color, or the like. In some embodiments, the interface may be configured such that only items that have not previously been returned are selectable by the user for returning.

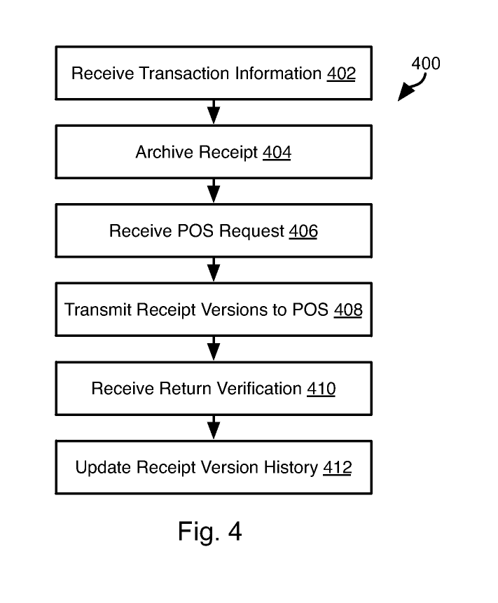

FIG. 4 illustrates a method 400 for maintaining electronic receipts, such as by a server system 102. The method 400 may include receiving 402 transaction information from a POS 106a, 106b in a POS network. The transaction information may be in the form of an electronic receipt, or the server system 102 may generate an electronic receipt based on transaction information received, such as a transaction identifier, items purchase, the price of items, taxes paid, coupons or discounts applied, and other transaction information.

The method 400 may include archiving 404 an electronic receipt from the transaction. Archiving 404 may include storage in any non-transitory storage medium. Archiving 404 may include storing the electronic receipt in a manner that is accessible with acceptable delay for use in other methods disclosed herein.

When a user attempts to return an item, a POS may transmit a request for a current version of a receipt representing a transaction in which the item was purchased. Accordingly, the method 400 may include receiving 406 a request from a POS for a copy of the electronic receipt. The server may then transmit 408 a current version of the electronic receipt ,or some or all versions of the electronic receipt, to the requesting POS.

In traditional receipt technologies a transaction may be assigned a transaction identifier. Inasmuch as millions of transactions may occur, transaction identifiers may be recycled, resulting in a collision. Accordingly, in some embodiments, when a request is received, all transactions having a transaction identifier may be retrieved. In some embodiments, a verification step may be performed prior to transmitting 408 the versions to the requesting POS. The verification step may include evaluating each of the transactions having the same transaction identifier to detect incongruences such as a geographic separation that is larger than a threshold, a time interval between transactions that is above a threshold, a lack of overlap in the items corresponding to the transactions, and the like. Other incongruences may also be detected. Where an incongruence is detected, a selection may be requested from the POS. Alternatively, only those transactions with the given transaction identifier that correspond to one or both of the date of the request and the location of the POS making the request may be returned. In some embodiments, a date of a transaction may be sent with a request in order to readily dismiss transaction identifiers from an undesired transaction. The step of detecting incongruent transactions with the same transaction identifier may be performed at the server 102 or at the POS 106.

After a POS has processed a return, the POS may transmit a verification or record of the return to the server. The server may receive 410 this return verification and update 412 the version history of the receipt. This may include creating a new version of the receipt that reflects the return or taking note of changes to the receipt as a result of the return.

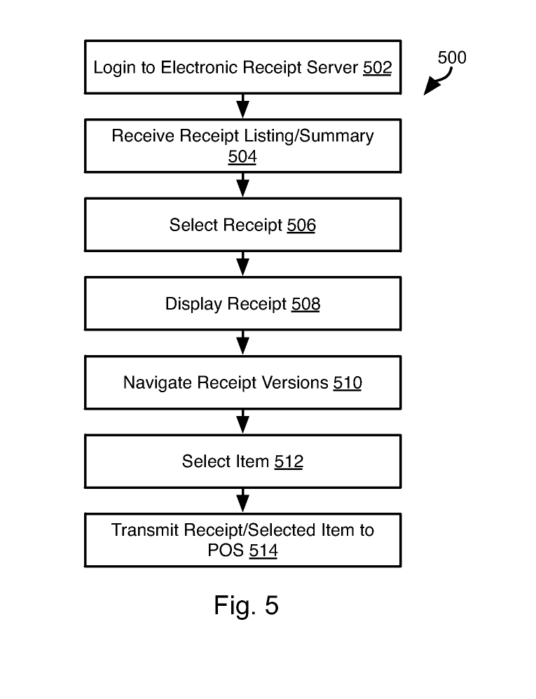

FIG. 5 illustrates a method 500 for using electronic receipts on a user computing device 104a, 104b. The method 500 may include logging in 502 the user or user computing device 104a, 104b onto a receipt server and receiving 504 one or both of electronic receipts and a listing or summary of some or all of the electronic receipts of the user. In some embodiments, only the most recent receipts, e.g. from the last N months may be received 504. In some embodiments, receipts may be locally stored on the user computing device 104a or some other storage device associated with a user due to some previous updating step such that logging in 502 and receiving 504 the receipts from a server may be omitted from the method 500.

A user may select 506 an electronic receipt or a user interface element corresponding to a receipt to invoke display 508 of the electronic receipt. A user may navigate 510 between versions of the receipt, such as by means of the interface shown in FIGS. 3A and 3B. A user may also select 512 an item from a receipt to select one or more items for returning. Identifiers of the selected item(s) may be transmitted 514 to a POS 106a, 106b. Transmitting 514 may be performed over a direct wireless connection to the POS 106a, 106b or by means of the server system 102. Transmitting 514 a selected item may include transmitting a transaction identifier of the transaction in which the item was purchased to the POS. In some embodiments, this step is omitted and one or both of an item identifier and an identifier of the transaction in which the item was purchased may be manually typed in or scanned from a document.

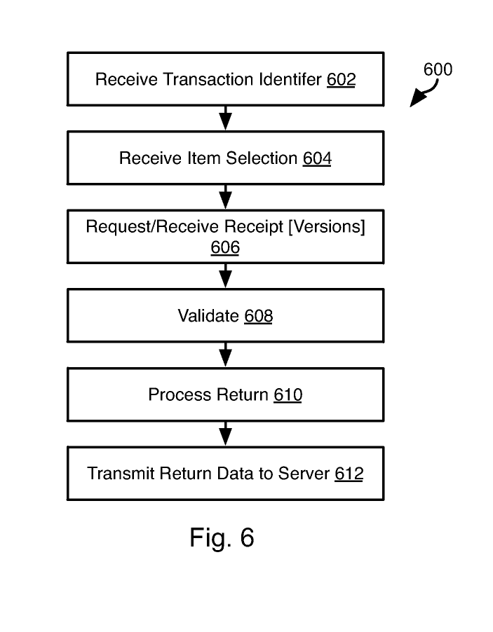

FIG. 6 illustrates a method 600 for processing a return at a POS 106a, 106b of a POS network. The method 600 may include receiving 602 a transaction identifier at the POS. The transaction identifier may be received 602 by a cashier or user manually typing in the identifier, scanning a barcode or QR code on a printed page or screen of a mobile phone encoding the transaction identifier, receiving the transaction identifier wirelessly from a mobile phone of a user adjacent the POS, or receiving the transaction identifier from a user's mobile phone by way of the server system 102 or some other type of network connection. In some embodiments, the user interface of a user computing device 104a-104b may enable a user to invoke display of a transaction identifier in a large font or “full screen” mode in order to make the identifier easily readable by a cashier or employee.

The POS may also receive 604 one or more item selections from the transaction corresponding to the received 602 transaction identifier. The item selection may be received by scanning a barcode or QR code on the item, manually entering the item identifier by a cashier or customer, receiving 604 the item selection wirelessly from an adjacent mobile phone of a user, receiving 604 the item selection from a user computing device by way of the server system 102 or some other network or some other means. In some embodiments, both the transaction identifier and item selection are received by the POS at the same time. In other embodiments, the item selection is received after the POS has requested and received 606 an electronic receipt corresponding to the transaction identifier or some or all versions of a receipt corresponding to the transaction identifier. The POS may request the electronic receipt from the server by transmitting the received 602 transaction identifier to the server system 102 and receiving 606 a corresponding electronic receipt, which may include some or all versions of the receipt or a marked up copy indicating modifications to an original transaction receipt.

The method 600 may further include validating 608 the item selection. Validating 608 may include verifying that any selected item is included on the receipt and that the most current version of the receipt indicates that the item hasn't previously been returned. In some embodiments, a current version of the receipt, or all previous versions of the receipt, may be printed out by the POS to enable visual inspection by a cashier. In some embodiments, validation 608 may be performed by a cashier after visually inspecting the current version of the receipt. If the item is found to have been actually purchased from the merchant and not previously returned, then the return may be processed 610 by the POS as known in the art. The POS may then transmit 612 details of the return to the server system 102. The details may include some or all of a transaction identifier, identifiers of each item returned, the amount refunded, and the manner in which the refund was provided.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

1. A method for processing returns, the method comprising:
receiving, by a computer system, an electronic receipt documenting a purchase made by a customer from a retailer;
receiving, by a point-of-sale (POS) terminal located within a brick-and-mortar store of the retailer, from a mobile computing device of the customer, while the customer is proximate the POS terminal, an identification of at least one item listed on the electronic receipt that is to be returned by the customer to the retailer;
using, by the POS terminal, the identification to complete a refund corresponding to the at least one item;
receiving, by the computer system, notification of the refund;
updating, by the computer system, the electronic receipt according to the refund;
receiving, by the computer system, a request for the electronic receipt; and
transmitting, by the computer system in response to the request, the electronic receipt indicating both the purchase and the refund.

2. The method of claim 1, wherein the transmitting comprises sending the electronic receipt indicating both the purchase and the refund to the mobile computing device.

3. The method of claim 1, wherein the transmitting comprises sending a plurality of electronic receipts each representing a different state of the purchase.

4. The method of claim 1, wherein the transmitting comprises sending the electronic receipt including graphical representations of changes in a state of the purchase.

5. The method of claim 1, wherein the transmitting comprises sending the electronic receipt including strike-through representing changes in a state of the purchase.

6. The method of claim 1, further comprising authenticating the POS terminal by the computer system prior to completion of the refund.

7. The method of claim 1, wherein the transmitting comprises transmitting text of the electronic receipt.

8. The method of claim 1, wherein the transmitting comprises transmitting an image of the electronic receipt.

9-22. (canceled)
